(19) United States
(12) Patent Application Publication
(10) Pub. No.: US 2006/0057249 A1
(43) Pub. Date: Mar. 16, 2006

(54) Method for fast production of cheese curds and cheese products produced therefrom

(75) Inventors: Lawrence I. Bell, Green Bay, WI (US); Jeng-Jung Yee, Green Bay, WI (US)

Correspondence Address: BRINKS HOFER GILSON & LIONE, P.O. BOX 10395, CHICAGO, IL, 60610, US

(73) Assignee: Schreiber Foods, Inc.

(21) Appl. No.: 10/940,509

(22) Filed: Sep. 13, 2004

(51) Int. Cl. A23C 9/12

(52) U.S. Cl. 426/36

(57) ABSTRACT

A method of making cheese curds includes the steps of: providing milk containing casein and having a solids content of between about 7% and about 25%; adjusting the pH of the milk to between about 5.8 and about 6.4; mixing a milk coagulating enzyme into the milk in a cheese making vat; allowing the milk coagulating enzyme to react with the casein for a time sufficient to cause a coagulum to form in the cheese making vat; cutting the coagulum while in the cheese making vat, said cutting occurring not more than 10 minutes after the milk coagulating enzyme is mixed with the milk; heating the cut coagulum in the cheese making vat to a temperature of at least 135° F. for a time sufficient to cause syneresis and the coagulum to form curds, the heating occurring over a period of not greater than 15 minutes; and separating the curds from whey resulting from the curd formation process. The curds may be mixed with additional ingredients to make cheese products, including processed cheese.

### BACKGROUND OF THE INVENTION

The present invention relates to cheese curds for processed cheese and other cheese products, and cheese products produced therefrom. In particular, the invention relates to a method for quickly producing cheese curds using an acidifying agent and a high-temperature cooking step that quickly causes liquid to separate from milk-coagulating-enzyme-treated casein in a fluid milk protein source.

Processed cheese has become a staple of the food industry. It is also a commodity, meaning that there are many suppliers of processed cheese. As a result, the price charged for processed cheese has a great impact on a supplier's share of the market. Thus processed cheese manufacturers are under constant pressure to reduce their costs. On the other hand, government regulations regarding the ingredients that can be used, and the desire for functional qualities such as taste, firmness, mouth feel and meltability, constrain efforts to reduce costs. In addition to the quality perceived by the consumer, functional qualities are also important in the manufacturing process.

One of the costs associated with making cheese curd, and hence a cost of making processed cheese made from such curd, is the capital equipment and operational cost in converting milk to cheese curd. Typical curd and cheese production processes require long holding times in large vats, especially while milk is being coagulated and the coagulated milk is gradually heated to effect syneresis, the expulsion of water and whey proteins from the cut coagulum. If the length of time that it took to make cheese curd could be reduced, the capital and operational costs could be reduced as well.

Another problem associated with the manufacture of processed cheese is variations in the finished product due to the variations in the cheese used to make the product. In traditional cheese, containing rennet and a starter culture, the cheese ages and gets softer over time. Thus, the age of the cheese when it is used to make processed cheese has an effect on the firmness of the processed cheese. This makes it complicated to produce a uniform quality processed cheese while juggling plant schedules and the use of different stocks of raw material as they come into inventory, because the age and the softness of the raw material cheese changes over time.

Hence, there is still a need for a process for making cheese curds in a reduced amount of time, which can then be used to make processed cheese that has good, uniform firmness, but at a reduced cost. Also, a process which could utilize conventional cheese making equipment with minimal modifications would be highly desirable.

### BRIEF SUMMARY OF THE INVENTION

It was realized by the present inventors that conventional cheese making processes are often designed to optimize the activity of bacterial starter cultures. Hence, holding times and process temperatures are chosen which favor the bacterial fermentation of lactose to lactic acid, and which keep the bacteria alive so that such activity can continue on after the cheese is made and stored. It was also realized that cheese curds used to make processed cheese do not need to have any residual starter culture activity. As a result, the process for making cheese curds can be optimized around the activity of the milk coagulating enzyme, and process steps and temperatures can otherwise be modified to optimize the process of making curds for use in processed cheese products. As a result, a method has been developed for rapid and economical production of curds which contain highly functional casein for use in processed cheese and other cheese products. The preferred process can be carried out using conventional cheese making equipment with slight modifications.

In a first aspect, the invention is a method of making cheese curds comprising the steps of: providing milk containing casein and having a solids content of between about 7% and about 25%; adjusting the pH of the milk to between about 5.8 and about 6.4; mixing a milk coagulating enzyme into the milk in a cheese making vat; allowing the milk coagulating enzyme to react with the casein for a time sufficient to cause a coagulum to form in the cheese making vat; cutting the coagulum while in the cheese making vat, said cutting occurring not more than 10 minutes after the milk coagulating enzyme is mixed with the milk; heating and stirring the cut coagulum in the cheese making vat to a temperature of at least about 135° F. for a time sufficient to cause syneresis and the coagulum to form curds, the heating occurring over a period of not greater than 15 minutes; and separating the curds from whey resulting from the curd formation process.

In a second aspect, the invention is a method of making a cheese product comprising the steps of: providing milk containing casein and having a solids content of between about 7% and about 25%; adjusting the pH of the milk to between about 5.8 and about 6.4; mixing a milk coagulating enzyme into the milk in a cheese making vat; allowing the milk coagulating enzyme to react with the casein for a time sufficient to cause a coagulum to form in the cheese making vat; cutting the coagulum while in the cheese making vat, said cutting occurring not more than 10 minutes after the milk coagulating enzyme is mixed with the milk; heating and stirring the cut coagulum in the cheese making vat to a temperature of at least about 135° F. for a time sufficient to cause syneresis and the coagulum to form curds, the heating occurring over a period of not greater than 15 minutes; separating the curds from whey resulting from the curd formation process; and mixing the curds with additional ingredients to make the cheese product.

In another aspect, the invention is a cheese curd having from about 32% to about 44% moisture, from about 17% to about 27% protein, at least 50% fat in dry matter and a low bacterial count of less than 25,000 cfu/gram.

A significant advantage of the preferred embodiment of the invention is that cheese curds can be made in a very short amount of time, thus reducing the cost of the cheese curds from capital equipment and operational cost perspectives. In addition, curds made by the preferred methods of the present invention give processed cheese an increased firmness compared to processed cheese made from conventional cheese curds. The curds can be used in a variety of cheese products. They can be made in such a short amount of time that it can be made as needed for processed cheese production.

These and other advantages of the invention will be most easily understood in light of the attached drawings and detailed description.

### BRIEF DESCRIPTION OF SEVERAL VIEWS OF THE DRAWINGS

FIG. 1 is a flow chart showing an embodiment of a method of making cheese curds according to the present invention.

FIG. 2 is a flow chart showing an embodiment of a method of making processed cheese from cheese curds according to the present invention.

FIG. 3 is a depiction of a cheese vat equipped with supplemental direct steam injection heating.

FIG. 4 is a depiction of a double-O vat with direct steam injection heating.

FIG. 5 is a depiction of a horizontal enclosed cheese vat equipped with direct steam injection.

### DETAILED DESCRIPTION OF THE DRAWINGS AND PREFERRED EMBODIMENTS

In the following passages, different aspects of the invention are defined in more detail. Each aspect so defined may be combined with any other aspect or aspects unless clearly indicated to the contrary. In particular any feature indicated as being preferred or advantageous may be combined with any other feature or features indicated as being preferred or advantageous

Definition of Terms

Unless indicated otherwise, percentages given for components in a composition are percentages by weight of the composition.

In the conventional manufacture of cheese, milk is processed to produce a semi-solid mass called “cheese curd” (or “curds”) and a liquid (whey). The curds contain casein, a small amount of lactose, most of the butterfat, minerals, and water. The whey contains whey proteins, most of the lactose, some of the butterfat, minerals, and water. The curds may be worked (e.g., stirred) and/or combined with certain flavor and taste producing ingredients, and/or ripened using bacteria to produce different varieties of “natural cheese”. With that background, the following definitions are given to explain terms used in describing and claiming the present invention.

“Milk” means the lacteal secretion obtained by the milking of one or more females of a mammalian species, such as cow, sheep, goat, water buffalo, or camel. Broadly speaking, such milk is comprised of casein (a phospho-protein), soluble (whey) proteins, lactose, minerals, butterfat (milkfat), and water. The amount of these constituents in the milk may be adjusted by the addition of, or the removal of all or a portion of, any of these constituents. The term “milk” includes lacteal secretion whose content has been adjusted.

Milk obtained by milking one or more cows is referred to as “cows' milk”. Cows' milk whose composition has not been adjusted is referred to herein as “whole milk”. It is comprised of casein, whey proteins, lactose, minerals, butterfat (milkfat), and water. The composition of “cows' milk” can be adjusted by the removal of a portion of or all of any of the constituents of whole milk, or by adding thereto additional amounts of such constituents. The term “skim milk” is applied to cows' milk from which sufficient milkfat has been removed to reduce its milkfat content to less than 0.5 percent by weight. The term “lowfat milk” (or “part-skim milk”) is applied to cows' milk from which sufficient milkfat has been removed to reduce its milkfat content to the range from about 0.5 to about 2.0 percent by weight.

The additional constituents are generally added to cows' milk in the form of cream, concentrated milk, dry whole milk, skim milk, or nonfat dry milk. “Cream” means the liquid, separated from cows' milk, having a high butterfat content, generally from about 18 to 40 percent by weight. “Concentrated milk” is the liquid obtained by partial removal of water from the whole milk. Generally, the milkfat (butterfat) content of concentrated milk is not less than 7.5 weight percent and the milk solids content is not less than 25.5 weight percent. “Dry whole milk” is whole milk having a reduced amount of water. It generally contains not more than five percent by weight of moisture on a milk solids not fat basis. “Nonfat dry milk” is the product obtained by the removal of water only from skim milk. Generally, its water content is not more than five weight percent and its milkfat content is not more than 1.5 weight percent.

Thus, the term “cows' milk” includes, among others, whole milk, low fat milk (part-skim milk), skim milk, reconstituted milk, recombined milk, and whole milk whose content has been adjusted.

The term “whey proteins” means milk proteins that generally do not precipitate in conventional cheese making processes. The primary whey proteins are lactalbumins and lactoglobulins. Other whey proteins that are present in significantly smaller concentrations include bovine serum albumin, euglobulin, pseudoglobulin, and immunoglobulins.

The term “fluid milk protein source” means a liquid which contains one or more proteins commonly found in milk, such as casein and whey proteins.

“Milk coagulating enzyme” means those enzymes that are capable of coagulating milk, including protease. The most common milk coagulating enzyme is calf rennet. Milk coagulating enzymes also include porcine rennet, microbial rennet, and rennet from fungal and vegetable sources. Included within the group of microbial rennet is fermentation derived chymosin. The milk coagulating enzyme reacts with the casein to cleave the protein and convert kappa-casein to para-casein. From literature, it appears that when 60-80% of the kappa-casein has been hydrolyzed, the casein micelle begin to aggregate and collapse together, initially forming a coagulum. As the coagulation process continues, any fat globules in the liquid are trapped within the protein matrix and curds are formed.

“Unrenneted casein” refers to casein which has not been subjected to action of milk coagulating enzymes.

“Conventional cheese” as used herein means a cheese made by the traditional method of coagulating milk, cutting the coagulated milk to form discrete curds, stirring and gradually heating the curds, draining off the whey, and collecting or pressing the curds. Milk from many different mammals may be used to make cheese, though cow's milk is the most common milk for cheese used to make processed cheese. Cow's milk contains whey proteins and casein at a weight ratio of about 1:4 whey proteins to casein. The conventional process for making natural cheese recovers the casein from the milk. Whey proteins dissolved in the whey are mostly discharged during the whey drainage step. The ratio of whey proteins to casein is between about 1:150 and about 1:40 for conventional cheese. For example, Cheddar cheese contains about 0.3% whey proteins. The ratio of whey proteins to casein is about 1:100 in typical Cheddar cheese, the most common conventional cheese. Cheddar cheese contains about 23% to about 26% protein by weight. Conventional cheese is often categorized by its age. Within 0 to 24 hours after the whey is drained, the material is often referred to as fresh curd. The curds are pressed and fused together to become cheese. Young cheese is often categorized as cheese that has been aged either 1-7 days, 1-2 weeks or 2 weeks to 1 month. Medium cheese is often categorized as aged 1-3 months or 3-6 months. Aged cheese is usually older than 6 months.

“American-type cheese” as used herein means the group of conventional cheeses including Cheddar, washed curd, Colby, stirred curd cheese and Monterey Jack. All must contain at least 50% fat in dry matter (FDM). Modifications in the historic process for making Cheddar cheese led to the development of the other three varieties. Washed curd cheese is prepared as Cheddar through the milling stage, when the curds are covered with cold water for 5 to 30 minutes. Washing increases moisture to a maximum of 42%. Stirred curd cheese has practically the same composition as Cheddar but has a more open texture and shorter (less elastic) body. It is manufactured as Cheddar except that agitation of cooked curd particles is used to promote whey drainage, and the Cheddaring and milling steps are eliminated. Colby cheese and Monterey Jack cheese are manufactured the same way as stirred curd except that cold water is added to wash and cool the curds when most of the whey has been drained away, thus increasing the moisture content to a maximum of 40% for Colby cheese and 44% for Monterey Jack cheese.

“Processed cheese” as used herein generally refers to a class of cheese products that are produced by comminuting, mixing and heating one or more varieties of curds or natural cheese into a homogeneous, plastic mass, with emulsifying agents and optional ingredients, depending on the class of processed cheese produced. The comminuted cheese is blended and sent to cookers or the like, which commonly heat the mass to a temperature of 150°-210° F., preferably 165°-190° F. During cooking, fat (if present) is stabilized with the protein and water by the emulsifying agents, which are typically citrate or phosphate salts, usually at a level of about 3%. The emulsifying agents cause the protein to become more soluble. Under these circumstances a stable emulsion of protein, fat and water occurs to provide a smooth, homogeneous mass. The hot mass is packaged directly, or formed into slices and packaged.

Even though the term “processed cheese” is not limited thereby, there are four main classes of processed cheese in the U.S.: pasteurized process cheese, pasteurized process cheese food, pasteurized process cheese spread and pasteurized process cheese product. All four classes of processed cheese are made with emulsifying agents. Standards of identity apply to pasteurized processed cheese and are established by the FDA. By those standards, whey solids, including whey proteins, may not be added to the pasteurized process cheese. The various types of processed cheeses are obtained depending on the processing conditions, the specific varieties of curds or natural cheeses used, and the additional ingredients added during the processing. Cheese sauce is another product which is a processed cheese, and may fit the standard of identity for pasteurized process cheese spread, or may be a non-standard product. Internationally, there are two Codex standards established for processed cheese, i.e., “Process Cheese” (also referred to as “Processed Cheese”) and “Process Cheese Preparation” (also referred to as “Processed Cheese Preparation”). For Process Cheese, cheese constitutes the largest single dairy ingredient used as a raw material, whereas for Process Cheese Preparation, cheese need not constitute the largest dairy ingredient used as a raw material. Both of these international standards also fit within the definition of “processed cheese” as used herein.

“Emulsifying agents” as used herein means emulsifying agents that can be used in the making of processed cheese. These include one or any mixture of two or more of the following inorganic salts: monosodium phosphate, disodium phosphate, dipotassium phosphate, trisodium phosphate, sodium metaphosphate, sodium acid pyrophosphate, tetrasodium pyrophosphate, sodium aluminum phosphate, sodium citrate, potassium citrate, calcium citrate, sodium tartrate, and sodium potassium tartrate. In processed cheese, these emulsifying agents act as calcium sequestering (or chelating) agents.

“Acidifying agents” as used herein means any food grade acid, and in particular, those that can be used in the making of processed cheese. These include vinegar, lactic acid, citric acid, acetic acid, phosphoric acid and mixtures thereof.

“Cheese product” as used herein includes compositions made from cheese curds, regardless of how such cheese curds are made. The term “cheese product” includes, and may otherwise be comparable to, conventional cheese (containing very small amounts of whey proteins), UF cheese (containing high levels of whey proteins), processed cheese, imitation cheese and intermediate materials in the processed cheese and imitation cheese making processes. The cheese curds may be made from fresh milk or other dairy liquids such as reconstituted dry milk powder. The fat content of the milk or other dairy liquid may be adjusted before making the cheese curds. Alternatively, the fat content of the cheese product may be adjusted after the curds have been formed when they are made into the cheese product.

Test Procedures

The present invention and the benefits thereof are most easily understood when described in terms of several standards for evaluating the firmness and melt properties of processed cheese.

Schreiber Melt Test

The L. D. Schreiber melt test is a well-known and accepted standardized test for determining the melt properties of cheese. The test uses a conventional electric kitchen oven and a standardized piece of cheese, and measures the change in size of the cheese piece after it is melted. The instructions for the procedure, as used in tests with results reported below, are as follows:

1. Preheat oven to 450° F. (232.2° C.).

2. Slice cheese 3/16 thick (5 mm). If cheese is already sliced, use 2-3 slices to get closest to the 3/16 thickness.

3. Cut a circle out of the cheese slice using a sharpened metal sampler with a diameter of 39.5 mm.

4. Center the cheese circle in a thin wall 15×100 mm petri dish, cover and place on the center rack of the oven. Do this quickly so the oven temperature does not drop below 400° F. (204.4° C.).

5. Bake for 5 minutes and remove. Up to 4 dishes may be done at the same time.

6. Once cooled, the melt is measured on the score sheet.

The score sheet comprises a series of concentric circles with increasing diameters. The first circle has a diameter of 40.0 mm. Each succeeding circle is 6.5 mm larger in diameter. The melted cheese receives a score of 1 if it fills the first circle, a score of 2 if it fills the second circle, etc. As used herein, the scores include a “+” (or “−”) indicating that the cheese was slightly larger (or smaller) than the indicated score ring.

Mettler Melt Test

The meltabilities of cheeses can also be compared using an apparatus for determination of dropping point or softening point, such as the Mettler FP 800 thermosystem. In such an apparatus, the temperature at which a plug of cheese falls through an orifice is measured. In general, cheeses with acceptable melt characteristics have a Mettler melt temperature below 200° F. Cheeses exhibiting non-melt characteristics will not melt at 230° F., which is the shut-off temperature of the Mettler FP 800 instrument as set up for this test, which prevents the temperature from rising too high and burning non-melting samples inside the instrument. The Mettler FP 800 instrument is set up with the start temperature at 100.0° F. and the heating temperature rate at 5.0° F./minute.

The instructions for sample preparation are as follows:

1. The sample cup (middle piece) is pushed through the cheese sample until the sample extrudes from the small top hole of the cup.

2. A knife is used to carefully trim around the cup and square off cheese at the top and bottom.

3. Samples of cheese are prevented from drying out before being analyzed.

4. The bottom holder and top holder of the sample cup are assembled with the center section.

5. The entire assembly, using the top holder stem, is placed in the oven and gently turned until it is seated on the bottom of the oven.

6. After the sample is placed in the instrument, the run/stop button is pushed. At this point there is a 30 second countdown while the oven temperature equilibrates at 100° F. The oven temperature will begin to rise and will shut off at the softening point of the cheese or at 230° F., in case the cheese does not soften and flow. The softening point reading will be printed on paper, or the end temperature (230° F.) will be printed if the cheese does not soften.

7. A fan inside the oven will turn on to bring the temperature back to 100° F. or below. When the fan has turned off, the entire assembly is removed from the oven and disassembled and cleaned.

Instron Firmness Measurement

The firmness of the cheese is measured by an Instron Tester (Model 5542—Canton, Mass.). The cheese is cut into chunk size (2″×3″×4″) and tempered at 40° F. overnight. A compressive loading force is applied to the cheese sample with a McCormic Fruit Tester plunger (8 mm diameter) attached to a load cell (500 Newton). The maximum force (kg F) recorded for the plunger as it travels downward (at a speed of 330 mm/min.) with a penetration depth of 11 mm into the cheese sample is defined as the firmness of the cheese. As can be appreciated, the firmness of any particular cheese product will be a function of many factors. However, the protein concentration in the product has a great effect on the Instron firmness. Therefore, when comparing the Instron Firmness of two different compositions, it is helpful to take into account the protein concentration. In some of the examples below, a relative Instron firmness number has been calculated by dividing the tested Instron firmness by the percentage of protein in the sample. For example, if a sample had an Instron firmness of 1.6 kg F and a protein level of 16%, the calculated Instron firmness/% protein would be 0.1 kg F/% protein.

The curd making process of the present invention will be described, and then a specific embodiment of the invention will be compared to a conventional curd making process. The use of the curds of the present invention in making processed cheese will then be discussed. Thereafter specific examples of the invention will be given.

The method of making cheese curds of the present invention starts with milk containing casein and having a solids content of between about 7% and about 25%. Virtually any fluid milk protein source containing casein may be used. Most typically whole milk or reduced fat milk with a fat content of between about 0.5% and about 2% (sometimes referred to as part skim milk) will be used, but skim milk may also be used. When there is a cost advantage, reconstituted milk may be used. The fluid milk protein source may have a higher solids content than whole milk; or its content may be adjusted in some other respect. For example, condensed milk, ultrafiltered milk, reverse osmosis milk or microfiltered milk may be used as long as the total solids level is in the required range. Of course the fluid milk protein source may be provided by mixing two or more different types of milk together. The fluid milk protein source will preferably contain casein and whey proteins at a ratio of casein to whey proteins of greater than 10:1, and a casein concentration of less than 4%.

The fluid milk protein source will preferably be pasteurized, although raw milk may also be used. Not only will pasteurization make the resulting product safer for food use, but the pasteurization step will deactivate organisms that might interfere with other steps in the process. After raw milk is pasteurized, it will generally be cooled to a temperature of between about 40° F. and about 120° F., more preferably between about 80° F. and about 115° F., most preferably between about 95° F. and about 115° F., before the milk coagulating enzyme is mixed with the fluid milk protein source. If the pasteurized milk is cooled and stored, or if milk is reconstituted from a dried milk, it will be heated up to these same temperatures.

The pH of whole milk is generally in the range of 6.6 to 6.7. Other milk sources that will typically be used will have a similar pH. The next step in the invention is to adjust the pH of the fluid milk protein source to between about 5.8 and about 6.4, more preferably to about 6.2, prior to mixing the milk coagulating enzyme with the fluid milk protein source. In traditional cheese making processes, a starter culture is added, and the lactose in milk is converted to lactic acid by fermentation to reduce the pH. In the present invention it is preferable to adjust the pH by adding an acidifying agent. Preferred acidifying agents are lactic acid and acetic acid.

In the next basic step, a milk coagulating enzyme is mixed into the milk in a cheese making vat. As used herein, the term “cheese making vat” is to be understood broadly to include vessels of all shapes and sizes that are of practical use in making cheese in a commercial manner. As noted earlier, the present invention is particularly well suited for use in equipment that needs to be only slightly modified compared to conventional cheese making equipment. In that regard, the amount of milk in the cheese making vat will preferably be at least 5,000 pounds, more preferably at least 25,000 pounds, and most preferably the amount of milk in the cheese making vat will be about 50,000 pounds or more.

A preferred milk coagulating enzyme is rennet, such as calf rennet, porcine rennet, microbial rennet and rennet from fungal and vegetable sources. A preferred rennet is fermentation derived chymosin. The amount of milk coagulating enzyme needed will vary depending on the concentration of casein in the fluid milk protein source, the time allowed for the reaction, the pH of the fluid milk protein source and the temperature at which it is carried out. In order to have a fairly quick reaction time, sufficient milk coagulating enzyme must be used and other process conditions must be within acceptable ranges.

The casein in milk is normally present in relatively stable micelles. Rennet induced milk coagulation involves two steps, the enzymatic step where the enzyme reacts with the casein to produce para-casein, and then the coagulation phase, which corresponds to the formation of a gel by aggregation and association of the enzyme modified micelles. The rate of these steps is heavily dependent on temperature and pH. Below about 50° F., the coagulation of milk does not occur. In the range of 50° F. to 68° F., the coagulation rate is slow. Above 68° F., it increases progressively up to 104° F. to 108° F. or higher, depending on the specific milk coagulating enzyme used, and then it diminishes again. Above about 150° F., coagulation no longer occurs as the enzyme is heat deactivated. As a result, the milk is preferably at a temperature in the range of 80° F. to 120° F., more preferably in the range of about 95° F. and about 115° F., when the milk coagulating enzyme is mixed in. Fermentation produced chymosin sold under the brand name “Chymax Extra” has an optimum enzyme activity at about 115° F.

The pH has a primary effect and a secondary effect. The activity of the enzyme is pH dependent. At a pH above 7, the enzyme is inactive. The maximum stability of the enzyme is displayed in a pH range of 5 to 6. The optimal pH for the enzyme to act on the casein is 5.5. Acidification also reduces the micelle stability, thus primarily affecting coagulation. Going from a pH of 6.7 to a pH of 5.6 increases the enzyme activity by a factor of 7, while the rate of aggregation of the micelles is increased by a factor of 30. As a result, and as noted above, the milk is preferably at a pH in the range of about 5.8 to about 6.4, more preferably about 6.2, when the milk coagulating enzyme is mixed in.

Optionally, a source of calcium may be added before a coagulum is formed. This may preferably be added before the milk coagulating enzyme is added, although it can be added at the same time as well. A preferred source of calcium is calcium chloride.

The adjustment of the pH and the addition of calcium are both steps that may be used to affect the resulting properties of the curds and the cheese product made therefrom.

The next basic step in the process is allowing the milk coagulating enzyme to react with the casein. The amount of time required will depend on several factors, including the pH, the concentrations of casein and milk coagulating enzyme, the temperature, and the calcium content. In any event, the time will need to be long enough so that the casein will form a coagulum in the cheese making vat. However, in the present invention, conditions will be chosen so that the time it takes for a coagulum to form is not more than 10 minutes. In general the enzyme should preferably be given between about 2 minutes and about 10 minutes to react. Lower pH values of the process of the present invention reduce coagulation time for two reasons. First, lower pH values are a more favorable environment for the basic enzyme activity. Second, a lower extent of kappa-casein proteolysis is required for aggregation of the casein micelles at lower pH values. Quiescent conditions are also preferred during the step of enzyme reaction. The milk coagulating enzyme will preferably be allowed to react with the casein for a period of about 4 minutes before the coagulum is cut.

In the next step of the process, the coagulum is cut while in the cheese making vat. This can be accomplished by any suitable means, such as harp wires or even using the agitators in a typical cheese making vat. It is preferable to cut the coagulum and then allow some time to pass for the coagulum to “heal” before the cut coagulum is heated. This healing step will typically last at least 2 minutes, and more preferably about 5 minutes, before the cut coagulum begins to be heated. All together the milk coagulating enzyme will preferably be allowed to react with the casein for a period of between about 2 minutes and about 20 minutes from the time the milk coagulating enzyme is mixed with the milk and the cut coagulum is heated.

The next basic step of the inventive method is to heat the cut coagulum to a temperature of at least about 135° F. for a time sufficient to cause syneresis and the coagulum to form curds. Stirring will also take place in this step to prevent the heated cut coagulum from matting together as the curds are formed. However, the heating and stirring need not be continuous nor occur at the same time. The stirring may be intermittent. This heating will occur over a period of not greater than 15 minutes, the duration of the heating period being measured from the time beginning when the cut coagulum begins to be stirred and its temperature is elevated, and ending when the whey starts to be separated. If heating starts before the stirring starts, then the time is not measured until the stirring starts. If stirring starts before the temperature begins to be raised, then the time starts to be measured when heating is started.

In conventional stirred curd cheese making processes, the renneted cut coagulum is gradually heated in the cheese making vat to temperatures in the range of only 90° F. to 105° F. One reason that moderate temperatures and slow heating rates are used is so that microbial activity will not be destroyed, and the cheese can then continue to age after it is formed. The present invention utilizes much higher temperatures. The cut coagulum in the present invention will preferably be heated to a temperature of between about 135° F. and about 170° F., more preferably between about 140° F. and about 150° F., and most preferably about 145° F. At these temperatures, if a starter culture were used, the starter activity would be deactivated significantly. However, as the curds are primarily intended for use in making processed cheese, and it is desirable to be able to use the curds soon, if not immediately, after they are made, the high temperatures for this step are not detrimental to the quality of the intended finished product. At these high temperatures, syneresis occurs very rapidly. The curds expel liquid, which includes whey protein as well as other soluble components in the original fluid milk, such as lactose.

In addition to a higher temperature, the preferred embodiment of the invention involves a more rapid heating of the cut coagulum after the enzyme treatment than is used in conventional cheese making processes. In conventional stirred curd cheese making, the cut coagulum is heated about 12° F. over a period of about 30 minutes. In the preferred embodiments of the invention, the heating is done more quickly. Preferably the cut coagulum is heated at least in part by direct steam injection, which can be done by introducing steam into the cheese vat. This may be accomplished by introducing the steam into the cheese making vat through an agitator having a steam injector built into it. FIG. 3 shows a traditional cheese making vat which has been further equipped with a steam injector built into the agitator, and the steam jacket modified to allow direct steam injection into the sides of the vat as well. FIG. 4 shows a “double 0” vat with a steam injector built into the agitator. Since a traditional cheese making vat has a steam jacket for heating, it may be preferably that the cut coagulum is also heated by steam jacket heating of the cheese making vat. Another method of heating the cut coagulum is to add a hot liquid into the cheese making vat. For example, whey drained off from a first vat could be heated in a heat exchanger and then added to a second vat after the curd is cut. Of course the heating may be accomplished by more than one method, in series or simultaneously. With direct steam injection, very quick heating rates are possible. The cut coagulum is preferably heated at a rate of at least 3° F./min., more preferably at a rate of at least 5° F./min., even more preferably at a rate of at least 10° F./min., and most preferably the cut coagulum is heated at a rate of at least 15° F./min. In preferred embodiments of the invention, the cut coagulum reaches 135° F. in a period of about 10 minutes or less, more preferably about 5 minutes or less, after heating is started. More preferably, the cut coagulum reaches 145° F. in a period of about 10 minutes or less, most preferably about 5 minutes or less, after heating is started.

The final step in the basic process is separating the curds from whey resulting from the curd formation process. The step of separating the whey from the curds may begin prior to the end of the heating step. The curds may be separated from the whey using any conventional method, such as draining, pressing and combinations thereof. Draining will typically involve draining through a screen in the bottom of the cheese vat, or pumping the curds and whey onto a drain table or a porous belt. Pressing will typically involve block pressing, hoop pressing, vacuum pressing and combinations thereof. Centrifugal separation, vibratory screening and other methods of separating the curds from the whey are contemplated but not preferred because the preferred methods use equipment typically found in conventional cheese making facilities.

Preferably the heated material will be cooled to a temperature of less than 120° F. before it is separated. More preferably it will be cooled to a temperature in the range of about 80° F. to about 100° F. prior to when the curds are separated from at least 90% of the whey. The material may be cooled by passing it through a heat exchanger, or by adding cold water, or even by taking the liquid separated at an earlier time, cooling it down, and then mixing that liquid back in.

Once the curds are formed and separated they can be used immediately to make cheese products. Alternatively they can be packaged and stored for later use. If the curds are to be stored, they should be cooled down to a temperature of about 40° F., and mixed with an acidifying agent to have a pH below 5.6, for food safety purposes. Cold brine may be used to help cool the curds.

The present invention is particularly suited for use in place of conventional cheese making processes that produce American-type cheese for use in processed cheese manufacturing. One such process is the “stirred curd Cheddar” process. The preferred embodiment of the invention can be best understood in comparison to such a process. In the following Table 1, the steps to a conventional stirred curd process are compared to steps of a preferred embodiment of the present invention, labeled in the table as “Fast Curd Cheddar.” Most interesting is a comparison of the cumulative minutes used by each process. In the Table, the time measurements begin with the addition of rennet.

TABLE 1

| | STIRRED CURD CHEDDAR | | | | FAST CURD CHEDDAR | | | |
|---|---|---|---|---|---|---|---|---|
| | (prior art) | | | | (inventive) | | | |
| | | | TIME | CUMLATIVE | | | TIME | CUMLATIVE |
| | ° F. | pH | MIN. | MINUTES | ° F. | pH | MIN. | MINUTES |
| Pasteurization (16 | 170 | 6.7 | | | 170 | 6.7 | | |
| sec. hold time) | | | | | | | | |
| Starter/Acidifying | 88 | 6.7 | | | 170 | 6.2 | | |
| Agent Addition | | | | | | | | |
| Ripening | 88 | 6.7 | | | | | N.A. | |
| Add Rennet (start | 88 | | 30 | 30 | 115 | 6.2 | 5 | 5 |
| of cheese make) & | | | | | | | | |
| Setting | | | | | | | | |
| Cutting & Healing | 88 | | 10 | 40 | 115 | 6.2 | 5 | 10 |
| Stirring | 88 | | 10 | 50 | | | N.A. | |
| Cooking | 102 | | 30 | 80 | 165 | 6.2 | 10 | 20 |
| Stir Out | 102 | | 35 | 115 | 165 | 6.2 | 0 | |
| Whey Drain | 102 | 6.2 | 10 | 125 | 165 | 6.2 | 5 | 25 |
| Curd Stirring | 98 | | 60 | 185 | 160 | 6.2 | 0 | |
| Curd Cooling | | | N.A. | | 95 | 6.2 | 5 | 30 |
| Salting Addition | 96 | | 10 | 195 | 95 | 5.2 | 5 | 35 |
| Packaging (end | 94 | 5.4 | | 195 | 93 | 5.2 | | 35 |
| of cheese make) | | | | | | | | |

As can be seen from Table 1, the initial step of the preferred embodiment of the present invention is the same as the initial step in a typical stirred curd Cheddar process. In both processes, milk with a pH of 6.7 is pasteurized at 170° F. for 16 seconds. In the next step, a starter culture is added in the stirred curd process, and an acidifying agent is added in the fast curd process. The pH is immediately reduced to 6.2 in the fast curd process, but it will take time for the starter to “ripen” in the stirred curd process. Up to this point, the elapsed time is not significant, nor much different between the two processes. However, with the addition of rennet in the next step, the time is kept track of. In a typical stirred curd process, the rennet and starter will be allowed to react for 30 minutes before the coagulum is cut, compared with only needing 5 minutes in the fast curd process for the rennet to cause a coagulum to form and be ready to be cut. The cutting and healing step in the fast curd process can be done in about 5 minutes, compared to taking 10 minutes in a conventional stirred curd process.

The biggest time savings occurs in the next steps. The conventional process requires 10 minutes for stirring, 30 minutes for cooking, and 35 minutes for the stir out step. In the fast curd process, no separate stirring step is required, and the cooking and stir out steps are carried out together in 10 minutes. Both processes involve a whey draining step, although the whey draining in the fast curd process can be performed in only 5 minutes, compared to 10 minutes in the conventional stirred curd process, where the curds are allowed to continue to ripen after a first whey draw occurs. The conventional process then uses 60 minutes for curd stirring, where the pH continues to drop, whereas the fast curd process does not need to take any significant time. However, the fast curd process does need 5 minutes for curd cooling that is not applicable to the stirred curd process. In the salt addition step, both salt and an additional acidifying agent are added to the curds in the fast curd process, whereas only salt is added to the stirred curds. Both processes end at this point, with the conventional curds being packaged, and the fast curds either being packaged or sent directly to a processed cheese making operation.

The cumulative time from when the rennet is added until the curds are ready for packaging or use in making a cheese product is 195 minutes in the conventional stirred curd process, but only 35 minutes in the preferred fast curd embodiment of the invention.

To make a cheese product, one or more additional ingredients will be mixed with the curds. If a cutting cheese for direct consumption is to be formed, salt (sodium chloride) and an acidifying agent can be mixed with the cheese curds and the curds packed into a form, such as a block or barrel. Thereafter the formed cheese will be cut into customer-size cut portions and sold in its cut form. As noted above, however, the curds are specifically advantageous for use in a processed cheese, such as pasteurized process cheese, pasteurized process cheese food, pasteurized process cheese spread and pasteurized process cheese product.

When the curds are going to be used to make a processed cheese, the curds will be ground and mixed with an emulsifying agent and other ingredients. The additional ingredients may include milkfat and salt (such as sodium chloride or potassium chloride). These can be mixed with the curds at the same time as the emulsifying agent. The processed cheese of the present invention will preferably comprises between about 1% and about 2.5%, and more preferably between about 1.5% and about 2% salt.

The step of mixing in additional ingredients can take place in a blender or some other piece of equipment, or it may take place directly in a processed cheese cooker. The mixing step may take place fairly soon before the curds are used to make processed cheese. However, in some embodiments of the invention, curds may be stored, either by themselves, or mixed with the additional ingredients, before they are used to make processed cheese. Preferably the cheese curds are made into a processed cheese within 16 hours, and more preferably within 4 hours, after being separated from the whey. Most preferably, the additional ingredients comprise a salt selected from the group consisting of sodium chloride, potassium chloride and mixtures thereof; and an acidifying agent, and the salt and acidifying agent are added to the curds, and thereafter the curds are introduced into a process cheese vessel, such as a process cheese blender or a process cheese cooker.

In another embodiment, the cheese curds are pressed and mixed with a salt selected from the group consisting of sodium chloride, potassium chloride and mixtures thereof, and an acidifying agent, and stored for a period of at least 1 day before being made into processed cheese. If the cheese curds are packed into a form, the pH will typically be adjusted to be between about 4.9 and about 5.6.

As can be seen from the above, the entire process can be carried out rapidly. Preferably the curds are separated from at least 95% of the whey within less than one hour, and more preferably within about 30 minutes, after the milk coagulating enzyme is mixed with the milk. Depending on the process parameters and quantities, in less than one hour, and more preferably in about 30 minutes, after the milk coagulating enzyme is mixed with the milk, additional ingredients can be mixed with the curds to make cheese products. The process can be scaled up in speed simply by equipment design, because the process does not require time for starter culture to act and produce a lower pH through fermentation.

The curds can be used to make processed cheese and other cheese products. The curds of the present invention can be readily cooked in typical processed cheese manufacturing equipment.

Controlling the calcium content of the curds is an important compositional parameter in the manufacture of processed cheese. In general, the state of the calcium in milk (colloidal or soluble) can be controlled with pH adjustments. When pH is reduced, more colloidal or “protein-bound” calcium will solubilize and move out into the serum phase of milk and become “soluble calcium.” Alternatively, as pH is increased the opposite effect occurs. Therefore by pH manipulation and subsequent rennet coagulation, one can control the residual amount of calcium left in the curds (colloidal) and the amount of calcium lost to the whey stream (soluble). When pH has been controlled, both curd calcium content and the extent of calcium sequestration through the action of sodium citrate is able to be controlled. It is believed that using the curds for processed cheese manufacture, a substantial increase in the finished processed cheese firmness can be achieved, which can be a major advantage in manufacture of superior processed cheese products. One of the key features of this invention is thus the development of a rapid method for production of curds with improved protein functionality over normal cheese protein supplied via full-fat barrel cheese made by traditional methods. Such a cheese curd will preferably have from about 32% to about 44% moisture, more preferably from about 32% to about 40% moisture, and from about 17% to about 27% protein, and at least 50% fat in dry matter. Because no starter culture is used, and because of the high temperature heating step, the curd will preferably have a low bacterial count, less than 25,000 cfu/gram.

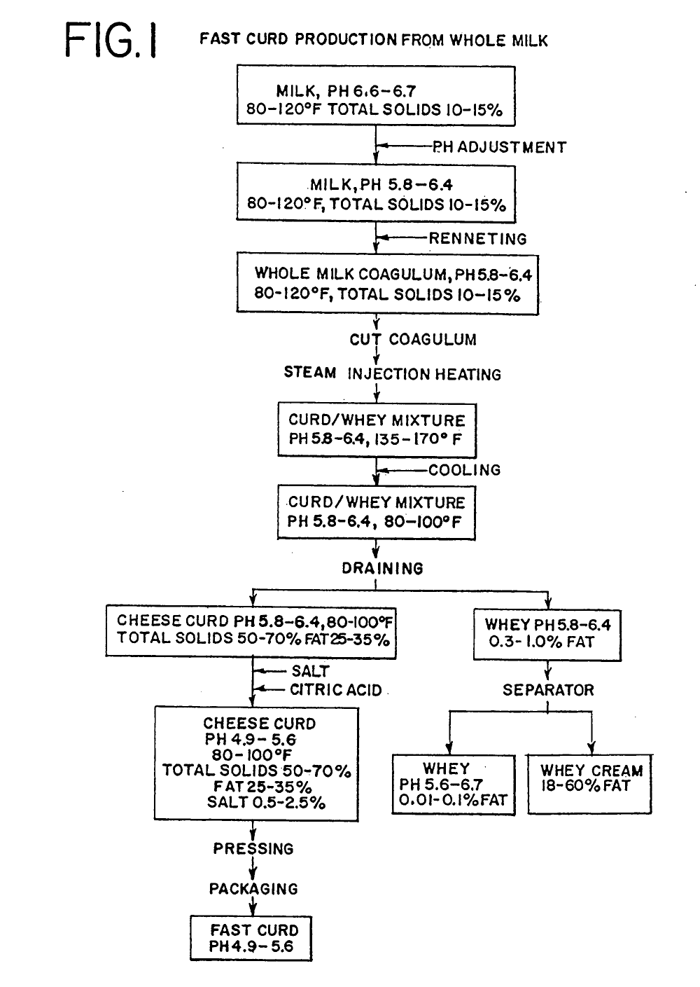

FIG. 1 shows a flow chart for a preferred process of making curds from whole milk. The prepared and pH-adjusted whole milk goes through a fairly typical rennet coagulation process in its initial stages. However, the heating step itself, and preferable when it occurs, is modified. In this process, whole milk with a pH of about 6.6-6.7, having a total solids content of 10-15%, is used. The whole milk will typically be pasteurized. It will then be cooled down to the desired temperature, preferably between 80° F. and 120° F. The pH is adjusted, preferably by the addition of acid, to a range of 5.8-6.4. Rennet is added and allowed to react with the casein in the whole milk, forming a coagulum. This coagulum is cut or otherwise broken. Heat is then applied rapidly and extensively via direct steam injection to reach temperatures of between 135° F. and 170° F., while the pH remains at 5.8-6.4. This achieves the proper amount of curd shrinkage and whey expulsion in a very short time. The curd/whey mixture is then cooled to a temperature in the range of 80° F. to 100° F., after which the whey and curds are separated. The curds have a solids content of between 50% and 70%, with a fat content between 25% and 35%. The whey has a fat content of between 0.3% and 1.0%. The fat is recovered from the whey by separation, producing a whey cream with 18%-60% fat and a whey with 0.01%-0.1% fat, and a pH of 5.6-6.7.

The cheese curd is mixed with salt and citric acid, producing a curd with a pH between 4.9 and 5.6, a total solids content of 50%-70%, a fat content between 25% and 35%, and a salt content of between 0.5% and 2.5%. These curds are then pressed and packaged.

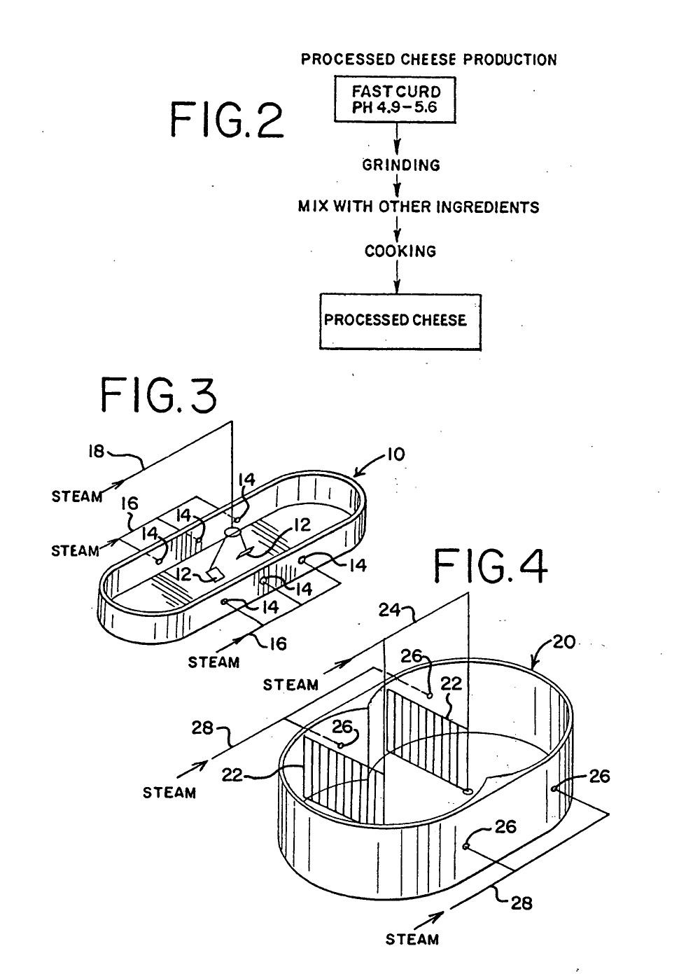

The curd resulting from the process of FIG. 1 can be made into processed cheese using the process shown in FIG. 2. The curds are ground, after which other ingredients are mixed in. The mixture is then cooked to produce processed cheese.

As noted earlier, one of the benefits of the preferred embodiment of the present invention is that it can be used to make cheese curds using conventional cheese making equipment with only slight modification. FIG. 3 shows a conventional cheese making vat 10 with such modifications. The conventional paddles 12 that are used to stir the milk and curds in the vat are modified so that steam can be supplied through piping 18 to the structure on which the paddles are mounted. This steam is directed through steam jets on the paddles 12. In addition, the vat is equipped with a plurality of steam jets 14 mounted to the side walls of the vat 10. These jets 14 are supplied by the same piping 16 that supplies steam to the steam jacket on the outside of the vat 10. These additional steam jets and piping are the only thing that needs to be added to conventional cheese making equipment in order to practice the present invention.

FIG. 4 shows a double-O type cheese vat 20 modified to practice the present invention. The two stirring paddles 22 typically used on the equipment are modified to feed steam from supply pipes 24 to steam jets located on the stirring paddles at a position that they will be submerged in the liquid in the vat. In addition, steam is directly injected into the liquid in the double-O vat 20 through steam jets 26 in the side walls of the vat, supplied by piping 28 used to supply steam to the steam jacket on the standard double-O vat.

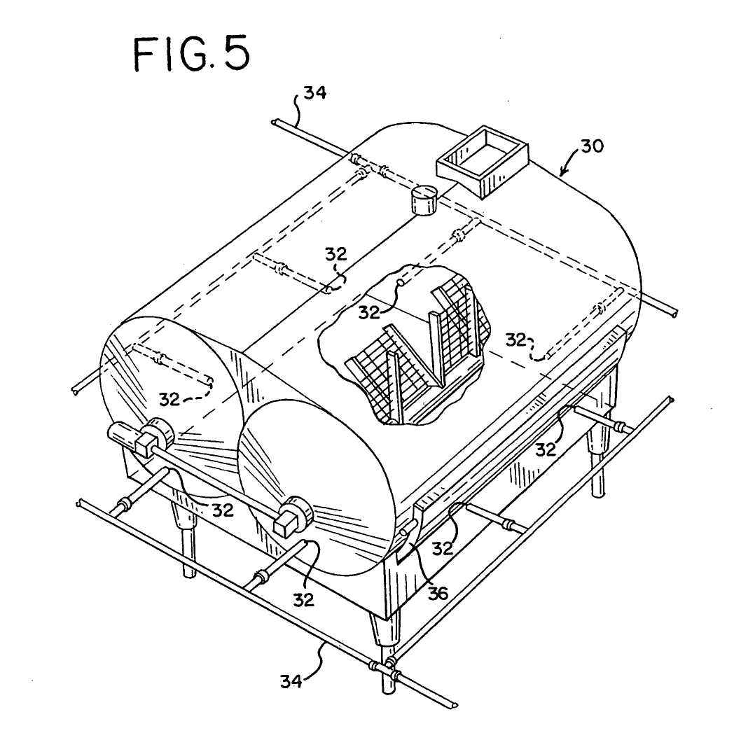

FIG. 5 is a depiction of a horizontal enclosed cheese vat 30 equipped with direct steam injection. Conventional horizontal enclosed vats are disclosed in U.S. Pat. No. 4,989,504, which is hereby incorporated by reference in its entirety. Such vats are modified for use in practicing the present invention, and as shown in FIG. 5, by including steam injection ports 32 supplied by steam lines 34. The direct steam injection ports are mounted on the lower part of the vat so as to be submerged when the vat contains a typical batch of milk. These are in addition to the conventional steam jackets 36 typically supplied with commercially available horizontal enclosed vats.

These vats can hold large volumes of milk. A conventional double-O vat may be 16′ 1″ long, 12′ 4¾″ high and 10′ 4″ wide, while a conventional horizontal enclosed vat may be 16′ 9″ long, 12′ 2½″ high and 11′ 6″ wide.

The following examples typify a method of making curds and a processed cheese by preferred embodiments of the invention.

### EXAMPLE 1

Curd Production from Whole Milk

Forty (40) gallons of raw milk was purchased from Lake to Lake Cheese Co. (Denmark, Wis.). The milk had the proximate composition shown in table 2:

TABLE 2

| | % Total | | | | | |
|---|---|---|---|---|---|---|
| | Solids | % Fat | % Protein | % Lactose | % Ash | pH |
| Whole Milk | 12.09 | 3.67 | 3.06 | 4.72 | 0.6 | 6.6 |

The milk at pH 6.6 was batch pasteurized (145° F. for 30 minutes) and then cooled (100° F.). The pasteurized milk was pre-acidified with 88 ml of acetic acid (diluted 50% with water) to reduce the pH to 6.2. The pasteurized milk (pH 6.2, 100° F.) was then transferred to a 50 gallon size open cheese vat (40.5×23.25×14 inches). 16 ml of rennet (Chymax Extra (2×), Chris Hansen, Milwaukee, Wis.) was added into the vat and mixed with milk with continuous agitation for additional 1 minute. The milk clotted quickly and formed a continuous soft gel coagulum. Five minutes after the rennet addition, the soft gel coagulum was cut into ¼″ cubes with conventional cheese wire cutters. The soft cut curds were allowed to heal for additional 5 minutes without mixing. During healing, some syneresis of the whey was noted.

The entire cut soft gel curd/whey mixture in the vat was further heated gradually from 100° F. to 145° F. by steam injection and with continuous gentle stirring with a cheese rake. The heating rate was controlled to heat the curd/whey mixture for 45° F. in 10 minute. The fast heating of the mixture to 145° F. in 10 minutes significantly hastened the rate of the syneresis (wheying off from the curd). As soon as the curd/whey mixture reached 145° F., the whey was drained with continuous stirring of the curd inside the vat. The composite whey collected during draining had the following composition shown in Table 3.

TABLE 3

| | % Total | | | | | |
|---|---|---|---|---|---|---|
| | Solids | % Fat | % Protein | % Lactose | % Ash | pH |
| Whey | 6.57 | 0.35 | 0.8 | 4.54 | 0.45 | 6.28 |

When all the free whey was drained out from the vat, the curd (32 lbs) was continuously stirred and mixed with additional salt (334 gram) and citric acid (145 gram). The curd, salt and citric acid mixture was then pressed in 20 lb hoop at 15 psig for 10 minutes to further press out the trapped whey. The finished fast curd after pressing had the following composition shown in Table 4:

TABLE 4

| | % Total | | | | | |
|---|---|---|---|---|---|---|
| | Solids | % Fat | % Protein | % Lactose | % Ash | pH |
| Finished Curd | 62.91 | 32.5 | 24.99 | 1.26 | 3.29 | 5.5 |

The finished fast curd had acceptable flavor, body and texture with comparable proximate composition as conventional curd made by the stirred curd make process. The finished fast curd was stored cold (<40° F.) and ready for use as cheese ingredient for processed cheese preparation.

### EXAMPLE 2

Processed Cheese Made with Fast Curd Obtained from Example 1

Process cheese formulas containing the fast curd from Example 1 in Formula 2A (50% replacement of conventional barrel cheese) and Formula 2B (100% replacement of conventional barrel cheese) were calculated and shown in Table 5:

TABLE 5

| | Processed Cheese Formula (lbs. per 10 lb cook) | |
|---|---|---|
| Cheese/Ingredient | Formula 2A | Formula 2B |
| Conventional Barrel | 3.16 | 0 |
| cheese (15 day old) | | |
| Curds from Example 1 | 3.03 | 6.06 |
| (10 days old) | | |
| Sodium citrate | 0.33 | 0.33 |
| Sorbic acid | 0.02 | 0.02 |
| Salt | 0.16 | 0.17 |
| NFDM | 0.65 | 0.60 |
| Conc. Milkfat (CMF) | 1.33 | 1.41 |
| Lactic Acid | 0 | 0 |
| Water | 1.31 | 1.41 |
| Total Weight | 10 | 10 |

Both formulas were targeted at the same finished product composition (39.8% moisture, 31.0% fat, 2.55% salt and 4.0% lactose).

The cheese and ingredient blends (Formulas 2A & 2B) were cooked in a 10 lb twin-screw Reitz cooker with indirect steam jacket heating at an auger speed setting of 94 rpm. The blend mixture was cooked to 175° F. for 10 minutes to form a homogenous molten plastic body, which was discharged from the cooker and collected into 14 ounce tubs for cooling (40° F., 3 days). The proximate composition, melt properties, and Instron firmness of the finished processed cheese are shown in Table 6.

TABLE 6

| | | Processed Cheese | | | | | | | |
|---|---|---|---|---|---|---|---|---|---|
| | | | | | | Meltability | | Firmness | |
| | | | | | | | Mettler | Instron | Instron |
| | Cheese | % | % | % | % | SFI | Melt | Firmness | kg F/ |
| Formula | Type | Moist. | Fat | Protein | Salt | Melt | (° F.) | (kg F) | protein |
| 2A | Conventional barrel | 38.34 | 32.5 | 17.93 | 2.72 | 4 | 154.2 | 2.762 | 0.154 |
| | cheese + Fast curds | | | | | | | | |
| | from Example 1 | | | | | | | | |
| 2B | Fast curds from | 39.26 | 31.5 | 17.73 | 2.56 | 4 | 158.1 | 2.616 | 0.148 |
| | Example 1 only | | | | | | | | |

The finished processed cheeses (Formulas 2A and 2B) made with the fast curds of this invention from Example 1 had acceptable flavor, body, and melt properties.

Because there is no need to hold cheese curds and whey before draining, or to hold the curd after whey drainage, for acidity to develop, the curds of the present invention can be made more rapidly than conventional cheese curds, thus reducing their cost compared to conventional cheese. In addition, there are several other advantages of the preferred embodiments of the invention. American-type cheese products can be made without concern for bacterial phage. Mild cheeses produced by the inventive methods will not age and change in flavor or firmness over time. Direct acidification makes control of the pH of the coagulum easy, as well as the pH of the final cheese products. This increase in control of the pH also allows for control of soluble and bound calcium, which affects both the nutritional and functional characteristics of the resulting cheese products. In addition, by reducing the pH before the renneting step, the milk coagulating enzyme is more active, reducing the amount of rennet that needs to be added. The temperature of the milk during curd formation can also be optimized for the enzyme used, without regard to conditions that would effect the starter culture, further decreasing the time and amount of enzyme that is needed. Because no bacterial fermentation is occurring, the pH stays constant during the renneting step, but the pH can be changed later as needed in the final product.

It should be appreciated that the methods and products of the present invention are capable of being incorporated in the form of a variety of embodiments, only a few of which have been illustrated and described above. The invention may be embodied in other forms without departing from its spirit or essential characteristics. All of the preferred embodiments relate to any or all of the independently claimed processes and products, taken either singly or in combination.

The described embodiments are thus to be considered in all respects only as illustrative and not restrictive, and the scope of the invention is, therefore, indicated by the appended claims rather than by the foregoing description. All changes that come within the meaning and range of equivalency of the claims are to be embraced within their scope.

1. A method of making cheese curds comprising the steps of:
a) providing milk containing casein and having a solids content of between about 7% and about 25%;
b) adjusting the pH of the milk to between about 5.8 and about 6.4;
c) mixing a milk coagulating enzyme into the milk in a cheese making vat;
d) allowing the milk coagulating enzyme to react with the casein for a time sufficient to cause a coagulum to form in the cheese making vat;
e) cutting the coagulum while in the cheese making vat, said cutting occurring not more than 10 minutes after the milk coagulating enzyme is mixed with the milk;
f) heating and stirring the cut coagulum in the cheese making vat to a temperature of at least about 135° f for a time sufficient to cause syneresis and the coagulum to form curds; and
g) separating the curds from whey resulting from the curd formation process;
h) the heating occurring over a period of not greater than 15 minutes, the duration of the heating period being measured from the time beginning when the cut coagulum begins to be stirred and its temperature is elevated, and ending when the whey starts to be separated.

2. The method of claim 1 wherein the milk comprises whole milk.

3. The method of claim 1 wherein the milk comprises reduced-fat milk with a fat content of between about 0.5% and about 2%.

4. The method of claim 1 wherein the milk comprises pasteurized milk.

5. The method of claim 1 wherein the milk comprises raw milk.

6. The method of claim 1 wherein the milk has its pH adjusted to about 6.2 prior to the mixing in of the milk coagulating enzyme.

7. The method of claim 1 wherein a source of calcium is added to the milk before the coagulum is formed.

8. The method of claim 7 herein said calcium source comprises calcium chloride.

9. The method of claim 7 wherein the source of calcium is added to the milk before the milk coagulating enzyme is mixed in.

10. The method of claim 1 wherein the milk is at a temperature of between about 80° F. and about 120° F. when the milk coagulating enzyme is mixed in.

11. The method of claim 1 wherein the milk is at a temperature of about 115° F. when the milk coagulating enzyme is mixed in.

12. The method of claim 1 wherein the milk coagulating enzyme is selected from the group consisting of calf rennet, porcine rennet, microbial rennet and rennet from fungal and vegetable sources.

13. The method of claim 12 wherein the milk coagulating enzyme comprises fermentation derived chymosin.

14. The method of claim 1 wherein the amount of milk in the cheese making vat in step c) is at least 5,000 pounds.

15. The method of claim 1 wherein the amount of milk in the cheese making vat in step c) is at least 25,000 pounds.

16. The method of claim 1 wherein the amount of milk in the cheese making vat in step c) is about 50,000 pounds or more.

17. The method of claim 1 wherein the milk coagulating enzyme is allowed to react with the casein under quiescent conditions.

18. The method of claim 17 wherein the milk coagulating enzyme is allowed to react with the casein for a period of about 4 minutes before the coagulum is cut.

19. The method of claim 1 wherein the milk coagulating enzyme is allowed to react with the casein for a period of between about 2 minutes and about 20 minutes before the cut coagulum is heated.

20. The method of claim 1 wherein the cut coagulum is allowed to heal for a period of at least 2 minutes before the cut coagulum begins to be stirred.

21. The method of claim 1 wherein the cut coagulum is allowed to heal for a period of about 5 minutes before the cut coagulum begins to be stirred.

22. The method of claim 1 wherein the cut coagulum is heated at least in part by direct steam injection.

23. The method of claim 22 wherein the steam is introduced into the cheese making vat through an agitator having a steam injector built into it.

24. The method of claim 22 wherein the cut coagulum is also heated by steam jacket heating of the cheese making vat.

25. The method of claim 1 wherein the cut coagulum is heated at least in part by addition of hot liquid.

26. The method of claim 25 wherein the cut coagulum is also heated by steam jacket heating of the cheese making vat.

27. The method of claim 1 wherein the cut coagulum is heated to a temperature of between about 135° F. and about 170° F.

28. The method of claim 1 wherein the cut coagulum is heated to a temperature of between about 140° F. and about 150° F.

29. The method of claim 1 wherein the cut coagulum is heated to a temperature of about 145° F.

30. The method of claim 1 wherein the cut coagulum is heated at a rate of at least 3° F./min.

31. The method of claim 1 wherein the cut coagulum is heated at a rate of at least 5° F./min.

32. The method of claim 1 wherein the cut coagulum is heated at a rate of at least 10° F./min.

33. The method of claim 1 wherein the cut coagulum is heated at a rate of at least 15° F./min.

34. The method of claim 1 wherein the cut coagulum reaches 135° F. in a period of about 10 minutes or less after heating is started.

35. The method of claim 1 wherein the cut coagulum reaches 135° F. in a period of about 5 minutes or less after heating is started.

36. The method of claim 1 wherein the cut coagulum reaches 145° F. in a period of about 10 minutes or less after heating is started.

37. The method of claim 1 wherein the cut coagulum reaches 145° F. in a period of about 5 minutes or less after heating is started.

38. The method of claim 1 wherein the curds are cooled to a temperature of between about 80° F. about 100° F. prior to when the curds are separated from at least 90% of the whey.

39. The method of claim 1 wherein the step of separating the whey from the curds begins prior to the end of the heating step.

40. The method of claim 1 wherein the curds are separated from the whey using a method selected from the group consisting of draining, pressing and combinations thereof.

41. The method of claim 40 wherein the method of draining is selected from the group consisting of draining through a screen, draining on a drain table, draining on a porous belt and combinations thereof.

42. The method of claim 40 wherein the method of pressing is selected from the group consisting of block pressing, hoop pressing, vacuum pressing and combinations thereof.

43. The method of claim 1 wherein the curds are cooled by the addition of liquid.

44. A method of making a cheese product comprising the steps of:
a) providing milk containing casein and having a solids content of between about 7% and about 25%;
b) adjusting the pH of the milk to between about 5.8 and about 6.4;
c) mixing a milk coagulating enzyme into the milk in a cheese making vat;
d) allowing the milk coagulating enzyme to react with the casein for a time sufficient to cause a coagulum to form in the cheese making vat;
e) cutting the coagulum while in the cheese making vat, said cutting occurring not more than 10 minutes after the milk coagulating enzyme is mixed with the milk;
f) heating and stirring the cut coagulum in the cheese making vat to a temperature of at least 135° F. for a time sufficient to cause syneresis and the coagulum to form curds;
g) separating the curds from whey resulting from the curd formation process;
h) the heating occurring over a period of not greater than 15 minutes, the duration of the heating period being measured from the time beginning when the cut coagulum begins to be stirred and its temperature is elevated, and ending when the whey starts to be separated; and
i) mixing the curds with additional ingredients to make the cheese product.

45. The method of claim 44 wherein the cheese curds are made into processed cheese.

46. The method of claim 44 wherein the cheese curds are made into a processed cheese selected from the group consisting of pasteurized process cheese, pasteurized process cheese food, pasteurized process cheese spread and pasteurized process cheese product.

47. The method of claim 45 wherein the cheese curds are made into a processed cheese within 16 hours after being separated from the whey.

48. The method of claim 45 wherein the cheese curds are made into a processed cheese within 4 hours after being separated from the whey.

49. The method of claim 45 wherein the cheese curds are pressed and mixed with a salt selected from the group consisting of sodium chloride, potassium chloride and mixtures thereof, and an acidifying agent, and stored for a period of at least 1 day before being made into processed cheese.

50. The method of claim 44 wherein the additional ingredients comprise an emulsifying agent.

51. The method of claim 50 wherein the emulsifying agent is selected from the group consisting of monosodium phosphate, disodium phosphate, dipotassium phosphate, trisodium phosphate, sodium metaphosphate, sodium acid pyrophosphate, tetrasodium pyrophosphate, sodium aluminum phosphate, sodium citrate, potassium citrate, calcium citrate, sodium tartrate, sodium potassium tartrate and mixtures thereof.

52. The method of claim 50 wherein the emulsifying agent comprises sodium citrate.

53. The method of claim 44 wherein the curds are mixed with a salt selected from the group consisting of sodium chloride, potassium chloride and mixtures thereof and packed into a form.

54. The method of claim 53 wherein the curds are adjusted to have a pH of between about 5.6 and about 4.9 prior to being packed into a form.

55. The method of claim 45 wherein the curds are cooled to a temperature of between about 80° F. about 100° F. and then ground before being used to make the processed cheese.

56. The method of claim 44 wherein the additional ingredients comprise a salt selected from the group consisting of sodium chloride, potassium chloride and mixtures thereof.

57. The method of claim 44 wherein the additional ingredients comprise an acidifying agent.

58. The method of claim 57 wherein the acidifying agent comprises citric acid.

59. The method of claim 44 wherein the additional ingredients comprise a salt selected from the group consisting of sodium chloride, potassium chloride and mixtures thereof; and an acidifying agent, and the salt and acidifying agent are added to the curds, and thereafter the curds are introduced into a process cheese vessel.

60. The method of claim 59 wherein the process cheese vessel is selected from the group consisting of a process cheese blender and a process cheese cooker.

61. The method of claim 44 wherein the curds are separated from at least 95% of the whey within less than one hour after the milk coagulating enzyme is mixed with the milk.

62. The method of claim 44 wherein the curds are separated from at least 95% of the whey within about 30 minutes after the milk coagulating enzyme is mixed with the milk.

63. The method of claim 45 wherein the processed cheese comprises between about 1% and about 2% of a salt selected from the group consisting of sodium chloride, potassium chloride and mixtures thereof.

64. The method of claim 45 wherein the processed cheese comprises about 1.5% of a salt selected from the group consisting of sodium chloride, potassium chloride and mixtures thereof.

65. The method of claim 1 wherein the curd has from about 32% to about 44% moisture, from about 17% to about 27% protein, at least 50% fat in dry matter and a bacterial count of less than 25,000 cfu/gram.
